(19) United States
(12) Patent Application Publication
(10) Pub. No.: US 2024/0406123 A1
(43) Pub. Date: Dec. 5, 2024

(54) System and Method Enabling Email Correspondence with Automated Conversational Agents

(71) Applicants: Zafar Khan, Redondo Beach, CA (US); Terrance Tomkow, Loa Angeles, CA (US)

(72) Inventors: Zafar Khan, Redondo Beach, CA (US); Terrance Tomkow, Loa Angeles, CA (US)

(21) Appl. No.: 18/665,289

(22) Filed: May 15, 2024

Related U.S. Application Data
(60) Provisional application No. 63/466,919, filed on May 16, 2023.

(51) Int. Cl. H04L 51/02; H04L 51/216

(52) U.S. Cl. CPC H04L 51/02; H04L 51/216

(57) ABSTRACT

An electronic messaging and document transformation system and method that allows email correspondence between a user and a chatbot. The system receives emailed prompts from users which may include a record of previous prompts and replies from the earlier back-and-forth email thread. The system parses the email to create a prompt and a conversation history consumable by the chatbot's API, transmits it to the chatbot, and records its response. The response is then returned to the user in the form of a reply to the originating email. The reply is constructed such that the user may reply to the response and such reply to the chatbot response then includes the earlier email thread that is used as contextual background information additionally re-submitted into the chatbot with the new query. The invention thereby accomplishes a refinement of a conversation with a chatbot that may be asynchronous without not need of the system to maintain or store prior chat content for context to provide the chatbot for new related queries.

### FIELD

This invention relates to the field of electronic communications and interactive natural language processing software and systems.

### BACKGROUND

Chat systems, also known as chatbots or conversational agents, have become increasingly popular in recent years due to their ability to interact with users in a natural language, providing helpful responses to their inquiries.

The earliest chat systems were simple rule-based systems that used pre-programmed responses to answer user queries. However, these systems were limited in their ability to handle complex queries and could not learn from their interactions with users.

With the advent of natural language processing (NLP) and machine learning (ML) technologies, chat systems have become more sophisticated. NLP allows chat systems to understand the nuances of human language, including slang, idioms, and cultural references. ML enables chat systems to learn from their interactions with users, improving their accuracy and response times over time.

Modern chat systems like Chat-GPT4 employ a combination of NLP, ML, and deep learning techniques to provide a more natural and engaging user experience (“chatbot server”). They can handle a wide range of queries and even provide personalized responses based on user preferences and past interactions.

In recent years, chat systems have also been integrated with other technologies to provide a simpler interface to access the back-end chatbot server, such as chat clients—voice assistants, messaging mobile apps, browser panes, and social media platforms. These chatbot clients make the chatbot server more accessible and convenient for users.

While chatbots have been integrated with many different applications, they have not been coupled with the oldest and most widespread of internet technologies, viz., email. For the same reasons it is often useful to email people rather than connect in some other way, it would be useful if it was possible to conduct an email correspondence with a chatbot. There are, however, technical obstacles that make this difficult. Most chatbot servers support RESTful APIs for the input of queries from chatbot clients. Though they are capable of extended conversations, the chatbot server does not store a history of its conversation with the user. That history must be saved by the chatbot client and submitted to the chatbot server each time the chatbot client sends a new query to the chatbot server. This history stored in the chatbot client that is resubmitted to the chatbot server with each reply query is what makes it such that the chatbot responses can become a back-and-forth conversation and can remain in context of the original query and even be more refined as the conversation carries on. This chatbot client role in concert with the chatbot server is not something standard email clients are capable of doing.

Even if future chatbot servers were to locally store the histories of conversations, they would require a user to log in to the chatbot service to access these records. Again, this is something normal email clients, like Microsoft Outlook, are not capable of doing. Applications built into email systems that provide AI-GENERATED recommendations on how to improve writing of email do not enable conversations with an AI chatbot. Applications that create email messages based on a user or sender of email prompts that transform the prompts into a message on route to the email recipient do not enable conversations with an AI chatbot but rather facilitate a conversation with a traditional email recipient.

### BRIEF DESCRIPTION OF INVENTION

The invention (FIG. 8) comprises an application server [8.2] that has an input interface (“application server” or “interface”) that may operate at a location remote from the user [8.1] and the chatbot server [8.3]. The application server interface is configured to receive email messages via SMTP or other common email transmission protocols [8.4]. The application server receives an email through normal email transmission protocols at a designated email address [8.5] (e.g. chat@rpost.ai). The user [8.1], by emailing prompts to this designated email address can carry on an extended correspondence with the chatbot server, receiving their replies [8.6] by email to the user's specific queries in an application server reformatted message [8.7]. The user may reply to the reply [8.8]. The reply to the reply initiates the process but with the history of the reply-thread. No special email client or sign-on is required for the sender/user.

More specifically, In FIG. 8, the application server (8.2) receives an email to an email address (8.5) associated with the application server from a user (8.1) via email transmission (8.4); the application server temporarily stores a copy of the original received message and transforms a copy the original received message into a message formatted for the chatbot server (8.3) and submits it to the chatbot server in using the chatbot server API, and receives the reply from the chatbot server via the chatbot server API (8.3) and reformats the reply into an email message format as if a reply message to the original received message, and pins that reply to the temporarily stored email body of the received message (8.7) and sends the reformatted reply email to the original user (to the email address FROM and/or the FROM and CC address in the original received email headers that are temporarily stored, then the application server purges the originally received email (8.4) and reformatted reply message (8.7). If there is a reply to the reformatted reply email (8.7) than that reply is received through the same process (8.8).

FIG. 9 illustrates the application server can receive multiple messages from different users simultaneously and mediate the communication of those messages to the chatbot server and manage the replies, segregating the context of each submission to the chatbot server and replies to the users by referencing the chat history in the email message body, and by the application server parsing such message body histories into chatbot server queries.

### BRIEF DESCRIPTION OF DRAWINGS

FIGS. 1 and 2 depict how conventional applications interact with chatbots, which is distinct from the other figures that depict the invention.

FIG. 1. User logs in to a conventional chat application and the conventional chat application submits to the chatbot server and that chatbot server replies with the web chat application storing conversation history.

FIG. 2. User logs in to a conventional chat application and the conventional chat application submits to the chatbot server and that chatbot server replies with the web chat application storing conversation history, and the reply from the user contains the original conversational history.

FIG. 3 shows the email sender corresponding with the chatbot via email with the interface as the mediator of the email back-and-forth dialog.

FIG. 4 shows the email sender corresponding with the chatbot via email with the interface as the mediator of the email back-and-forth dialog, including the replies re-submitting prior context to the chatbot without the interface storing correspondence history.

FIG. 5 shows the email sender corresponding with the chatbot via email with the interface as the mediator of the email back-and-forth dialog, including the replies re-submitting prior context to the chatbot without the interface storing correspondence history, including the interface acting as a mediator to select which chatbot is best suited by the mediator or other criteria to furnish a response to the sender inquiry, with the interface mediating at the analysis step which chatbot based on prior context and the most recent query.

FIG. 6 depicts a conventional communicating computing system.

FIG. 7 depicts a conventional communicating computing system in a cloud computing network.

FIG. 8 depicts the overall process of a user communicating by email with the chatbot.

FIG. 9 depicts the overall process of a user communicating by email with the chatbot with multiple senders submitting information to the chatbot separately in parallel or sequentially.

FIG. 10 depicts multiple branded sending addresses routing to the interface which acts as a mediator for communicating the queries to a set of distinct AI chatbots.

FIG. 11 depicts a reply to a sender of a query by email to the chatbot.

FIG. 12 depicts a reply to the reply to the sender of a query by email to the chatbot.

FIG. 13 depicts a reply to the reply to the sender of a query by email to the chatbot.

### DETAILED DESCRIPTION OF THE DRAWINGS

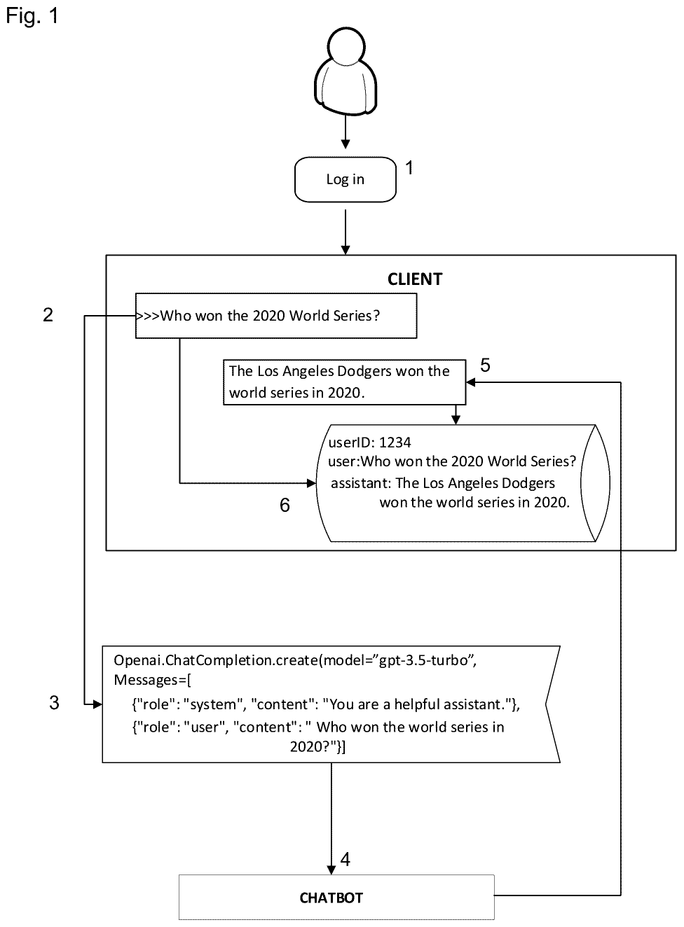

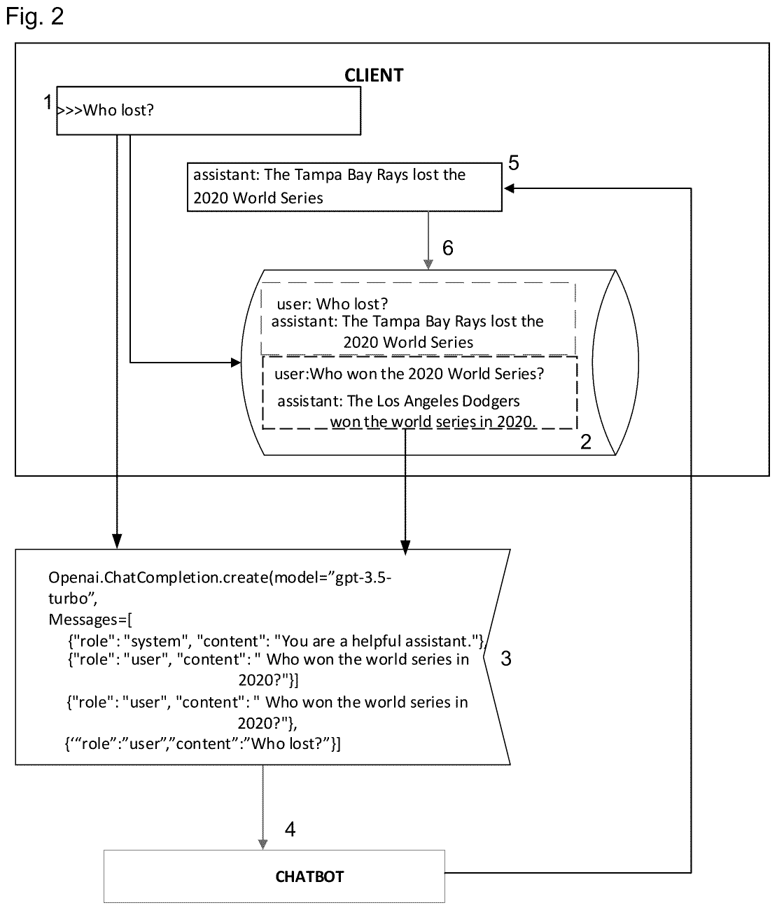

FIGS. 1 and 2 illustrate the typical implementation of a chatbot client. Since the client application must store the histories of users, users must be required to perform some form of login [1.1] to identify themselves when initiating a conversation with the chatbot. The client provides a text or speech user interface for creating queries. The client transmits [1.2] an initial query formatted as required by the chatbot's API [1.3] to the chatbot. The chatbot's reply is transmitted to the client and displayed to the user [1.5]. So that the conversation can continue, the client stores the user's initial query, together with the chatbot's response, in a database with an identification of the user [1.6]. So that the chatbot can answer the user's follow-up question [2.1] in the context of the first, the client must now recover the first question and the chatbot's response from the data store [2.2] and combine the first question and its response with the new query in the format required by the chatbot's API [2.3] before transmitting it to the chatbot [2.4]. When the chatbot responds to the second query [2.5], the client must store the query and this response in the database [2.6]. Subsequent queries must include the complete history of the preceding conversation in each transmission to the chatbot.

By contrast, the invention comprises an interface that may operate at a location remote from the user and the chatbot server. The Interface receives an email at one email address. By emailing prompts to this address, any number of users can carry on an extended correspondence with the chatbot, receiving their replies by email. No special email client or sign-on is required because the user is identified as the sender of the email.

The method employed in the interface system exploits the fact that all standard email systems include the text of the originating message in the body of a message replying to it. This is in accordance with RFC 2822, which offers an example that illustrates a series of three messages that make up a conversation thread between John and Mary. John first sends a message to Mary, Mary then replies to John's message, and then John replies to Mary's reply message.
Date: Fri, 21 Nov. 1997 11:00:00-0600
From: John Doe <jdoe@machine.example>
To: Mary Smith <mary@example.net>
Subject: Re:Re: Saying Hello

This is a reply to your reply.
Date: Fri, 21 Nov. 1997 10:01:10-0600
From: Mary Smith <mary@example.net>
To: John Doe <jdoe@machine.example>
Subject: Re: Saying Hello
Hello yourself!
Date: Fri, 21 Nov. 1997 09:55:06-0600
From: John Doe <jdoe@machine.example>
To: Mary Smith <mary@example.net>

This is a message just to say hello.
So, “Hello.”

Different email programs distinguish the threaded messages using different delimiters.

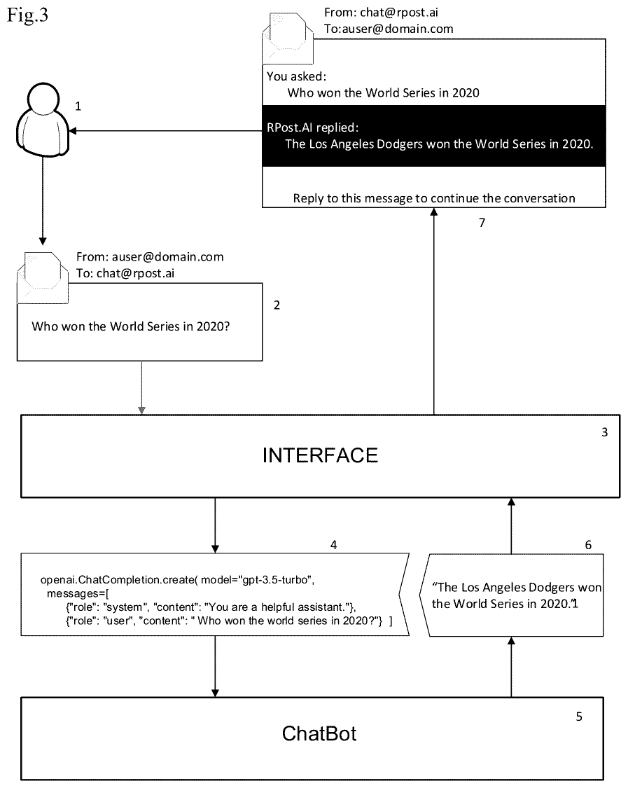

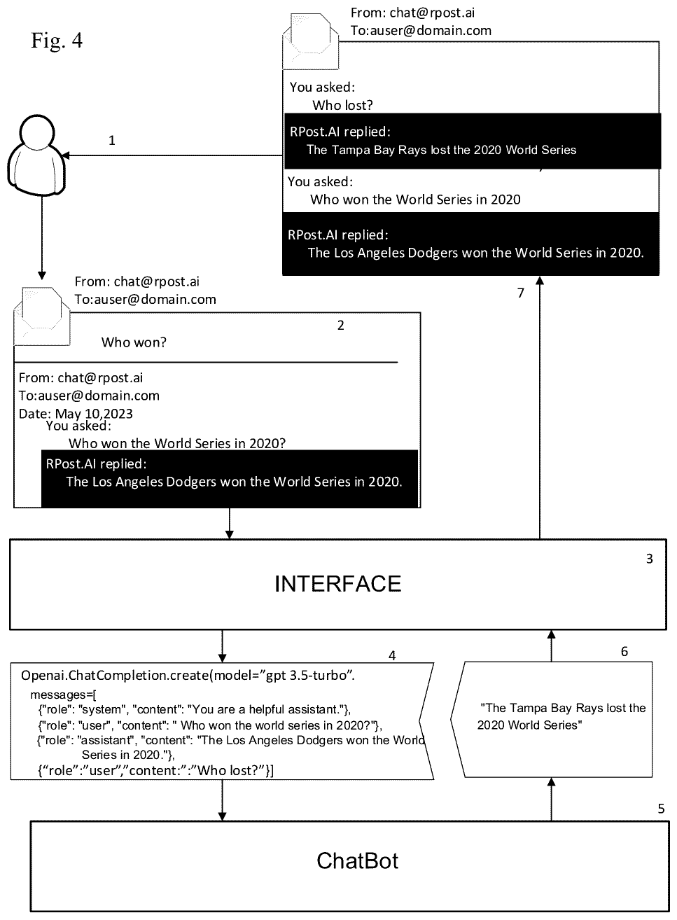

FIGS. 3 and 4 illustrate the relationship between an ordinary email client and a chatbot under the invention. The correspondence between the email client and the chatbot is conducted in a series of messages and replies mediated by an interface. Users [3.1] do not have to log on to web site or use a specialized application; they have only to send their queries to the public address of the Interface [3.2]. The Interface extracts the user's query from the received email message, formats it in the manner required by the chatbot's API [3.4], and transmits it to the chatbot [3.5]. On receiving the chatbot's reply, the Interface formats the query and response as an email and returns it to the user with the instruction to reply to the email to continue the conversation. When the user replies to the email, the user's email application will, in conformity with RFC 2822, append the body of the replied to email. [4.2]. On receipt of this email, the Interface [4.3] extracts the new query and the preceding query and answer from the email, formats them in the manner required by the chatbot's API [4.4], and transmits them to the chatbot [4.5]. On receiving the chatbot's reply to the new query, the Interface transmits it to the user in the form of an email reply that includes the history of the conversation.

Because the history of the conversation is preserved in the emails themselves, the system of the invention does not require that message histories be stored at the Interface.

Further, the user may sub it by email [5.1] the query which is parsed by the interface [5.2] and the content is analyzed and categorized with chatbot 1, which then determines at the interface which chatbot is best suited to respond to the original query and routes [5.3] the query via the specialized chatbots (chatbot 1, 2, 3, 4 . . . ) with the interface receiving the response from the specialized chatbot and formatting the reply to the original sender [5.4].

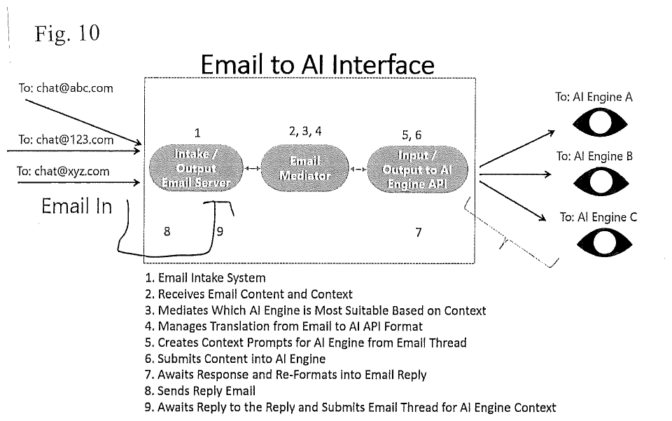

Further, there may be multiple senders sending to various branded email addresses of set up by a sender administrator to route to the interface [FIG. 10.1] and the interface may consider the domain of the to address to add context to submit to the AI engine. For example, if the TO address were chat@BarAssociation.ai, then the interface may add as a prompt to the AI engine “act as a legal advisor” which will solicit a different response from the AI chatbot, or may direct the interface to route the query to a specialized legal chatbot.

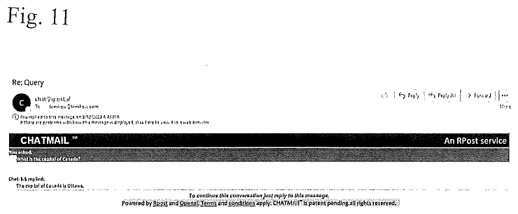

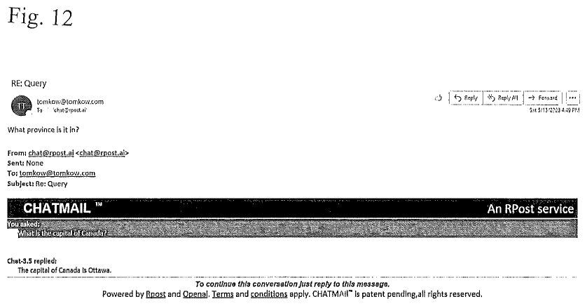

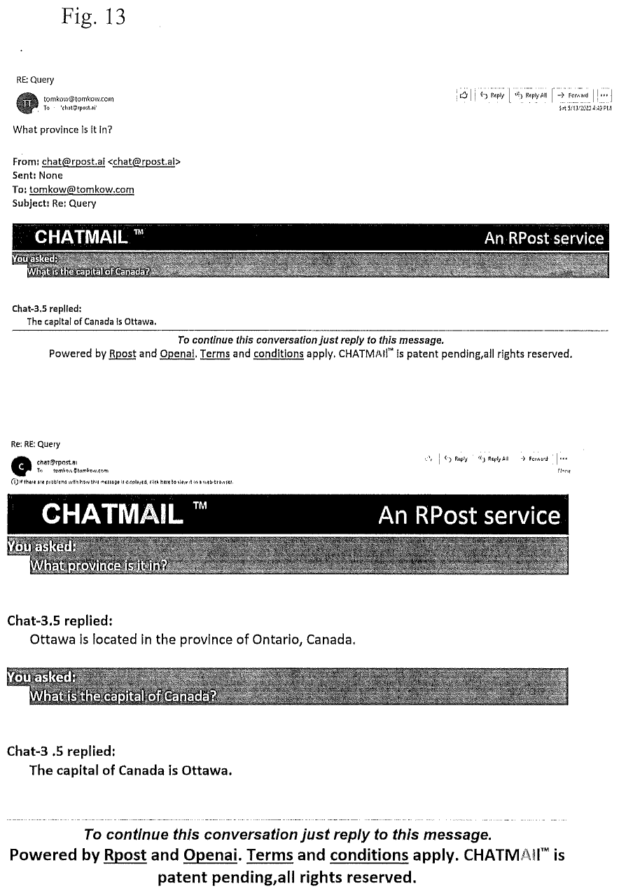

The query reply may be formatted to differentiate from the original question and the chatbot response (FIGS. 11 and 12) and the history of the original email thread in replies may be preserved in the text part of the email but not placed in the HTML part of the email view for the email user, which will preserve the context for the interface to analyze and resubmit as replies to the chatbots. Alternatively, the history of the original email thread in replies may be preserved in the HTML part of the email view in white text so as to be unreadable by most users with common email clients but remain machine readable by the interface for the interface to analyze and resubmit as replies to the chatbots.

The invention does not store email content other than while processing the submission from the interface to the chatbot [5.2, 5.3] and receiving the chatbot response and reformatting the message [5.4] after which the interface does not store the message or responses. This preserves the ability for the interface to operate computationally efficient.

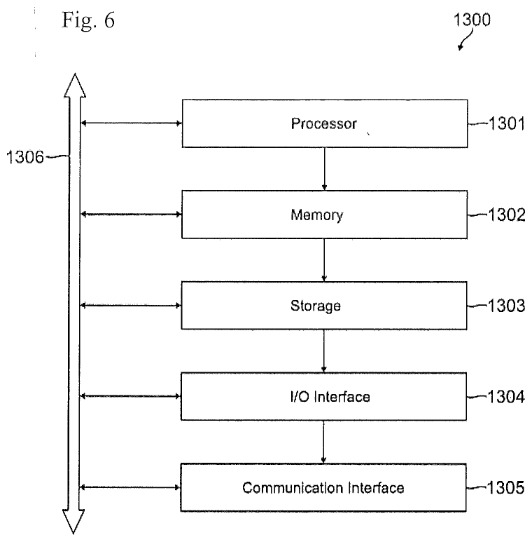

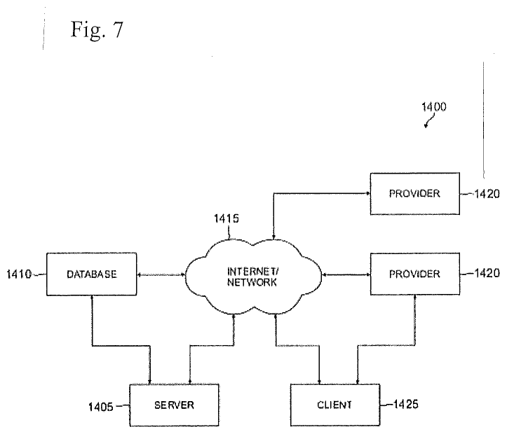

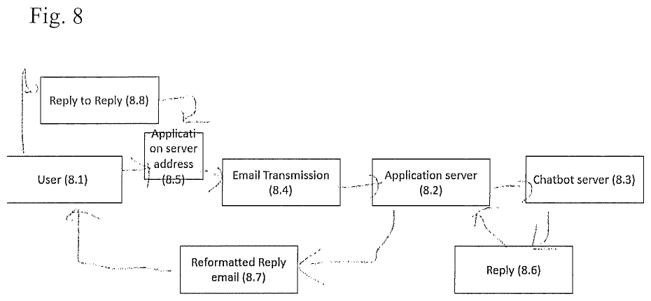

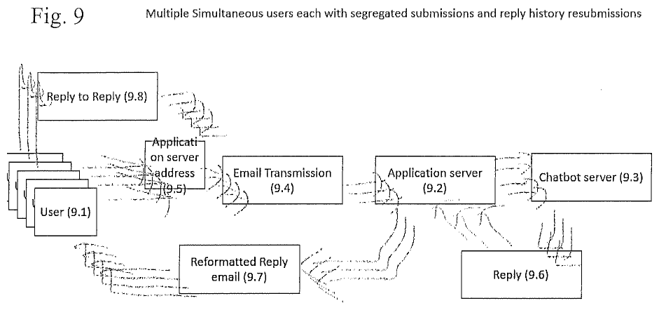

The invention may operate on a server at the sender or remote from the sender, and remote from the chatbots. The server and computing environment are described in FIGS. 6 and 7 generally.

FIG. 6 illustrates an exemplary computer system 1300 which may be used with some embodiments of the present invention, which may be, for example, a server or a client computer system. Computer system 1300 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, etc. Computer system 1300 may be a combination of multiple forms. Computer system 1300 may include one or more computer systems 1300, be unitary or distributed, span multiple locations, span multiple systems, or reside in a cloud (which may include one or more cloud components in one or more networks).

In one embodiment, computer system 1300 may include one or more processors 1301, memory 1302, storage 1303, an input/output (I/O) interface 1304, a communication interface 1305, and a bus 1306. Although this disclosure describes and illustrates a particular computer system having a particular number of particular components in a particular arrangement, this disclosure contemplates other forms of computer systems having any suitable number of components in any suitable arrangement.

In one embodiment, processor 1301 includes hardware for executing instructions, such as those making up software. Herein, reference to software may encompass one or more applications, byte code, one or more computer programs, one or more executable module or API, one or more instructions, logic, machine code, one or more scripts, or source code, and or the like, where appropriate. As an example and not by way of limitation, to execute instructions, processor 1301 may retrieve the instructions from an internal register, an internal cache, memory 1302 or storage 1303; decode and execute them; and then write one or more results to an internal register, an internal cache, memory 1302, or storage 1303. In one embodiment, processor 1301 may include one or more internal caches for data, instructions, or addresses. Memory 1303 may be random access memory (RAM), static RAM, dynamic RAM or any other suitable memory. Storage 1305 may be a hard drive or other form of storage device that can store data (including instructions for execution by a processor).

Note, however, while there may be a hard drive the point of our system/method is that it doesn't require a storage device. One could be added for alternate embodiments or for other purposes but they are not integral to the invention.

In one embodiment, storage 1303 may be mass storage for data or instructions which may include, but not limited to, a HDD, solid state drive, disk drive, flash memory, optical disc (such as a DVD, CD, Blu-ray, and the like), magneto optical disc, magnetic tape, or any other hardware device which stores computer readable media, data and/or combinations thereof. Storage 1303 maybe be internal or external to computer system 1300.

[This generic description describes every system on the internet.]

In one embodiment, input/output (I/O) interface 1304 includes hardware, software, or both for providing one or more interfaces for communication between computer system 1300 and one or more I/O devices. Computer system 1300 may have one or more of these I/O devices, where appropriate. As an example but not by way of limitation, an I/O device may include one or more mouses, keyboards, keypads, cameras, microphones, monitors, displays, printers, scanners, speakers, cameras, touch screens, trackball, trackpad, biometric input device or sensor, or the like.

In still another embodiment, a communication interface 1305 includes hardware, software, or both providing one or more interfaces for communication between one or more computer systems or one or more networks. Communication interface 1305 may include a network interface controller (NIC) or a network adapter for communicating with an Ethernet or other wired-based network or a wireless NIC or wireless adapter for communications with a wireless network, such as a Wi-Fi network. In one embodiment, bus 1306 includes any hardware, software, or both, coupling components of a computer system 1300 to each other.

FIG. 7 is a graphical representation of an exemplary network 1400 that may be used to facilitate the various embodiments of the present invention. Server 1405 is operated by a services organization 1420, and typically includes at least one processor, input and output equipment or devices, memory, storage, and a communication interface. The server 1405 also operates under the control of specialized software programming commands that are designed to carry out the various processes described above. It should be understood that while the exemplary network 1400 is described in terms of a server 1405 operated by a services organization 1420, the server 1405 could be operated by a third party hired by the services organization or under the control of the services organization. The server 1405 could also be operated by a third party independent of the services organization, which then provides information and/or data to the services organization from which the services organization may provide services to a client 1425 of the services organization.

Note, however, while there may be a hard drive the point of our system/method is that it doesn't require a storage device. One could be added for alternate embodiments or for other purposes but they are not integral to the invention.

A data storage device 1410, which may be separate from the server 1405, but not necessarily, may be accessible to the server 1405, and may be used for storing date related to information and any other data related to operation of the various embodiments of the system and method described above. The data storage device 1410 may directly connected to the server 1405, or it may be accessible to the server 1405 through a network or the Internet 1415. The data storage device 1410 may also be a virtual storage device or memory located in the Cloud.

These diagrams are describing some embodiments of the various embodiments of this disclosure, those skilled in the art will understand that there are other embodiments and more details within each of these embodiments not depicted in these diagrams.

Although the disclosed system has been described hereabove with reference to certain examples or embodiments, various additions, deletions, alterations and modifications may be made to those described examples and embodiments without departing from the intended spirit and scope of the disclosed heat exchange system. For example, any elements, steps, members, components, compositions, reactants, parts or portions of one embodiment or example may be incorporated into or used with another embodiment or example, unless otherwise specified or unless doing so would render that embodiment or example unsuitable for its intended use. Also, where the steps of a method or process have been described or listed in a particular order, the order of such steps may be changed unless otherwise specified or unless doing so would render the method or process unsuitable for its intended purpose. Additionally, the elements, steps, members, components, compositions, reactants, parts or portions of any embodiment or example described herein may optionally exist or be utilized in the absence or substantial absence of any other element, step, member, component, composition, reactant, part or portion unless otherwise noted. All reasonable additions, deletions, modifications and alterations are to be considered equivalents of the described examples and embodiments and are to be included within the scope of the following claims. The disclosure is limited only by the scope of the appended claims.

### ADDITIONAL EMBODIMENTS

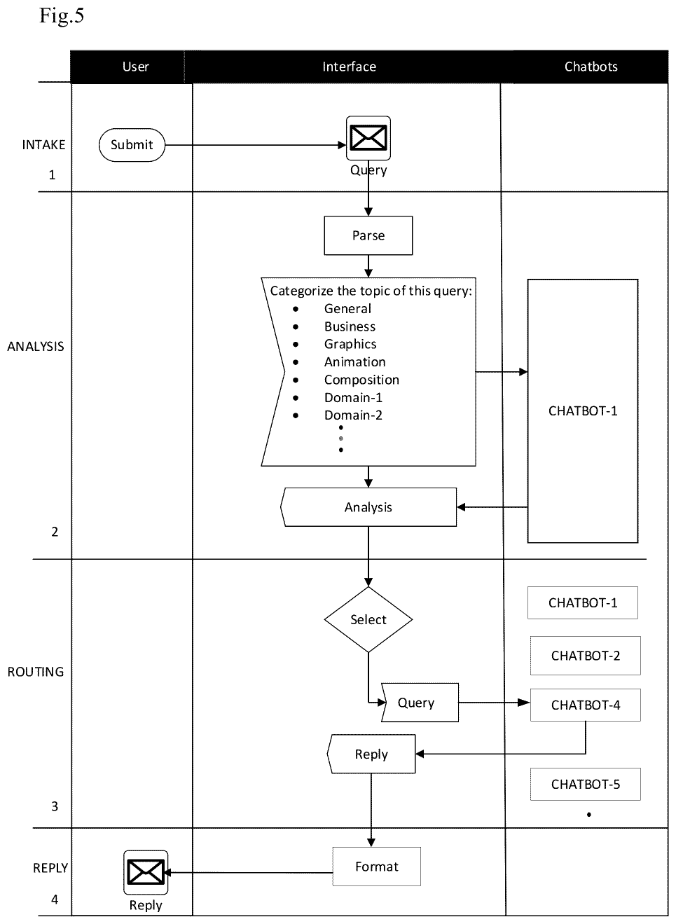

Breakthroughs in large language model (LLM) natural language processors (NLP) have led to a proliferation of specialized chatbot systems. Because the Interface of the invention mediates between the user and the chatbot, it is also capable of routing users' queries to different systems and to exploit the NLP capabilities of external chatbots in choosing the best chatbot to answer the submitted query. FIG. 5 and FIG. 10 illustrates this process. The user submits a query to the Interface [5.1]. In the analysis phase, the Interface parses the received email to extract the new query and the conversation history. The query and history are submitted to a chatbot with the instruction to report their topic in a format that can be processed by the Interface. When the chatbot replies with the topic of the query the Interface selects one from a set of chatbots the one best suited to process queries with that topic and submits the query to that chatbot [5.3]. When the reply from that chatbot is received the interface formats it and the conversation history as a reply email and sends it to the user [5.4].

In FIG. 10, there are multiple users that are submitting messages and replies, which could be simultaneously (U1, U2 . . . ) and each could be emailing to the same address (e.g. chat@rpost.ai) or could be emailing to another address that is set to relay to the application server (e.g. chat@company.ai routes to the same input server as chat@rpost.ai). A6 is the application server, and chatbots can be different chatbot servers (CB1, CB2 . . . ).

These diagrams are describing some embodiments of the various embodiments of this disclosure, those skilled in the art will understand that there are other embodiments and more details within each of these embodiments not depicted in these diagrams.

What is claimed is:

1. An electronic document transformation system allowing an extended email correspondence between a user and a chatbot comprising:
an input device configured to receive email messages;
an information transformation module that parses a received message at those junctures indicative of the history of messages and replies recorded therein and transforms the excerpted records into a format interpretable by the chatbot as a history of user queries and chatbot replies and submits the formatted history to the chatbot and receives the chatbot's response to the most recent query and creates an email message which represents the chatbot response as a reply to the received message that includes the history of messages and replies recorded in the received message and transmits the created email to the sender of the original message.

2. A system of claim 1 in which the transformation module, in addition to conveying the user's query to the chatbot, amends the query to direct or limit the chatbot's response.

3. A system of claim 1 in which the transformation module sets parameters exposed by the chatbot's API controlling the character of the chatbot's responses.

4. A system of claim 1 in which the transformation module
analyses the received query and determines which of a multiplicity of chatbots is best suited to answer the query; and
queries the optimal chatbot and returns its reply as the reply to the submitted query.

5. An electronic document transformation apparatus that allows an extended email correspondence between a user and a chatbot comprising:
receiving an email at an input device configured to receive emails at the apparatus application server which is remote from the email sender;
an information transformation module at the apparatus application server that parses the received email at those junctures indicative of the history of messages;
the apparatus application server transforming the received message parts into a format that is required to be submitted to a chatbot server that is remote from the apparatus application server,
the apparatus application server submitting the message parts along or with additional prompts for context by API into the chatbot server,
the apparatus application server configured to receive the response by API from the chatbot server,
the response from the chatbot server including the history of what was submitted by the application apparatus server, and
the apparatus application server to construct a new email message in an email format that has a conventional email reply thread format for an end user.

6. Claim 5 where the application apparatus server send the reply to the original sender email address that is part of the original submission.

7. Claim 6 where no message content submitted by the user to the apparatus application server or returned by the chatbot server to the application apparatus service is stored at the apparatus application server.

8. Claim 6 where no message content submitted by the user to the apparatus application server or returned by the chatbot server to the application apparatus service is stored at the apparatus application server other than message submission identifying information associated with the sender submission email address.

9. Claim 6 where copied recipients of the submission by the sender to the application apparatus server receive a copy of the response prepared by the apparatus application server, and of there is a reply received by the application apparatus server from one of the original copied users, all of the original copied recipients receive a copy of the new reply generated at the apparatus application server no message content submitted by the user to the apparatus application server or returned by the chatbot server to the application apparatus service is stored at the apparatus application server.

10. Claim 6, where the reply email adds the response to the original message thread without the application server (or the chatbot server) storing the original message; the content of the original message is included in the chatbot server submission by the application server and also therefore in the chatbot server history; the application server, upon receipt of the reply from the chatbot server then reconstructs the conversation into an email format mimicking typical email reply string familiar formats, and sends the transformed reply to the user.

11. Claim 6 where the transformation module
analyses the received query and determines which of a multiplicity of chatbots is best suited to answer the query; and
queries the optimal chatbot and returns its reply as the reply to the submitted query.

12. The electronic document transformation apparatus of claim 5, configured to allow an extended email correspondence between a user and a chatbot server that does not store any email after mediating the reply from the chatbot server wherein
the application apparatus server is configured to append the new email message into a temporarily stored original received email message and send the reply to the original sender email address that is part of the original received temporarily stored email, and the apparatus application server subsequently deletes the original message and the reply message from temporary storage.

13. Claim 12, where the transformation module
analyses the received query and determines which of a multiplicity of chatbots is best suited to answer the query; and
queries the optimal chatbot and returns its reply as the reply to the submitted query.

14. An electronic document transformation apparatus that allows an extended email correspondence between a user and a chatbot server that does not store any email after mediating the reply from the chatbot server comprising: the apparatus application receives the original email, reads it, composes a query for the chatbot server, asks the chatbot server the question, receives the response from the chatbot server to compose a reply to the sender, sends a reply to the sender pinned the temporarily stored original message, then deletes the original message and the reply message from temporary storage.

15. Claim 14, where the transformation module
analyses the received query and determines which of a multiplicity of chatbots is best suited to answer the query; and directs its query to the optimal chatbot server.
